(19) United States
(12) Patent Application Publication
(10) Pub. No.: US 2016/0019802 A1
(43) Pub. Date: Jan. 21, 2016

(54) NEURAL ADAPTIVE LEARNING DEVICE AND NEURAL ADAPTIVE LEARNING METHOD USING REALTIONAL CONCEPT MAP

(71) Applicant: EDUCLOUD INC., Fort Lee, NJ (US)

(72) Inventors: Sang-Ho WON, Yancheon-gu Seoul (KR); Gang-Wook KIM, Mapo-gu Seoul (KR)

(73) Assignee: EDUCLOUD INC., Fort Lee, NJ (US)

(21) Appl. No.: 14/774,280

(22) PCT Filed: Mar. 14, 2014
(86) PCT No.: PCT/KR2014/002200

§ 371 Date: Sep. 10, 2015

(30) Foreign Application Priority Data
Mar. 14, 2013 (KR) 10-2013-0027503

(51) Int. Cl. G09B 7/00

(52) U.S. Cl. CPC G09B 7/00

(57) ABSTRACT

Provided are a neural adaptive learning device and a neural adaptive learning method using a relational concept map, which: store problems for learning, concepts related to the problems, and relations among the concepts; provide a cloud map as a relational concept map to a user by utilizing the problems, the concepts, the concept map, and the learning history; relate and connect the learning history with the problems and one or more concepts; enable the extraction of the concept selected by the user and searching for the desired concept of the user; provide the cloud map for a user equipment of the user by using the extracted concept and the related concept; and extract the connected problems from a problem storage unit to enable learning.

### TECHNICAL FIELD

The present invention generally relates to a neural adaptive learning device and a neural adaptive learning method, using a relational concept map. More particularly, the present invention relates to a neural adaptive learning device and method using a relational concept map, which enables a learner to autonomously understand a concept of terms necessary for learning and to improve the learner's ability to solve problems related to the concept, by providing adaptive learning content.

This application claims the benefit of Korean Patent Application No. 10-2013-0027503, filed Mar. 14, 2013, which is hereby incorporated by reference in its entirety into this application.

### BACKGROUND ART

To acquire knowledge and to check the knowledge, problem-based learning (PBL) and problem-based assessment are widely used by learners. Via a learner's solution to a worksheet, such methods have the following intentions: reporting achievement of the learning process, retraining learners, and examining efficiency of the current learning process.

Construction of an item pool is a commonly used method to prepare a worksheet for assessment. In other words, to make a worksheet, problems are selected from the item pool storing multiple problems, depending on the scope of learning, a difficulty level, and a chapter.

However, in the case of a learning assessment method based on item pools, because metadata of a problem is limited to information about a chapter, including the problem and information corresponding to the difficulty level of the problem, the assessment is performed in a range of the chapter embraced by the problem.

On the other hand, a chapter including a certain problem may cover various concepts. In this case, a learner has different degrees of comprehension and achievement for each of the concepts within a single chapter, but a conventional learning device and method do not consider such aspects. As a result, only by distributing marks for each question and adding the marks in the chapter assessment and problem solving process, customized learning cannot be provided. Therefore, it is difficult to improve the learner's understanding through such an approach.

In the United States, new learning methods are being implemented for mathematical education, and learning processes are changing. Common Core State Standards (CCSS), which is a common curriculum designed by mathematics educators and academicians, has been promoted as a new learning standard so that students will be prepared for global competition. However, though the new learning process has been implemented, much effort and research are still required to develop a learning device or learning method appropriate for effective learning.

### DISCLOSURE

### Technical Problem

An object of the present invention is to enable a learner to understand concepts necessary for learning and to develop a learner's logical thinking ability so as to solve a problem based on the understanding of the concepts. Also, the present invention intends to provide a learning method that enables each learner to autonomously learn logical concept structures of mathematics and the like.

Another object of the present invention is to improve a learner's ability to reason, thus enabling the learner to solve various transformed problems related to the concepts previously learned. Also, the present invention intends to provide a learning method customized to a user using an adaptive system by reflecting the degree of understanding of a concept based on a percentage of correct answers by the learner.

A further object of the present invention is to enable a learner to perform multi-dimensional and parallel learning. The present invention intends to provide a learning method to help a learner understand how learned concepts and other concepts are combined and transformed based on the problem.

Also, by a learning device and method according to the present invention, the present invention intends to help a learner realize concepts and items at which he or she is weak and produce in the learner a sense of accomplishment when he or she learns something new.

### Technical Solution

According to the present invention, an adaptive learning device using a relational concept map is a learning device that displays learning content in a user's terminal connected by a network, which processes the learning content provided to a user using a processor and a memory, to assist the user in learning. The adaptive learning device includes: a problem storing unit in which problems are stored for learning; a concept storing unit in which concepts are stored in connection with the problems; a concept map storing unit in which a relation between the concepts is stored; a learning history storing unit in which a learning history for each user is stored; and a processing unit for providing the user with a cloud map, which is a relational concept map, using data stored in the problem storing unit, the concept storing unit, the concept map storing unit, and the learning history storing unit, wherein the user's learning history for each of the problems is connected with the problem and one or more of the concepts, and wherein the processing unit comprises: a concept cloud extracting unit for extracting a concept, selected by the user, from the concept storing unit; a concept cloud searching unit for searching the concept storing unit for a concept desired by the user; a cloud map output unit for providing a cloud map to the user's terminal, using a concept and a relevant concept extracted from the concept storing unit and the concept map storing unit; and a concept problem output unit for extracting a problem connected to a concept from the problem storing unit and for outputting the problem.

Also, according to the present invention, an adaptive learning method using a relation concept map is a learning method that displays learning content in a user's terminal connected by a network, and that processes and provides the learning content using a processor and a memory to assist the user in learning. The adaptive learning method provides a learning method using a learning device, including a problem storing unit in which problems are stored for learning; a concept storing unit in which concepts are stored in connection with the problems; a concept map storing unit in which a relation between the concepts is stored; a learning history storing unit in which a learning history for each user is stored; and a processing unit for providing the user with a cloud map, which is a relational concept map, using data stored in the problem storing unit, the concept storing unit, the concept map storing unit, and the learning history storing unit. The adaptive learning method includes: connecting, by the learning history storing unit, each user's learning history about each of the problems with the problem and one or more of the concepts; extracting, by the concept cloud extracting unit, a concept selected by the user from the concept storing unit; searching, by the concept cloud searching unit, the concept storing unit for a concept desired by the user; providing, by the cloud map output unit, a cloud map to the user's terminal, using a concept and a relevant concept extracted from the concept storing unit and the concept map storing unit; and by the concept problem output unit, extracting a problem connected to a concept from the problem storing unit and outputting the problem.

### Advantageous Effects

According to the present invention, departing from a conventional learning process for remembering a solution, a user may acquire a deep understanding of mathematics through a concept-based approach. Problems may be conceptually categorized, and a concept common to both of the problems may be studied. Accordingly, a user may solve a problem via understanding of the concept, though the problem is new to the user; thereby, learning effects can be improved by systematically relating a problem and a concept, a root concept and a sub-concept, a concept and another concept, and a problem and another problem. Also, by using accumulated learning history as big data, an adaptive learning method may be provided to a user.

The present invention provides a new online neural adaptive learning platform. The present invention relates to an adaptive and intelligent learning system, which may provide an individualized adaptive program for mathematics via computers, based on a neural network model for logical thinking. Data collected in a previous step is used to determine a next step, and is also used to determine the previous step.

The present invention helps develop students' logical thinking, and analyzes a user's pattern, and determines the degree of understanding concepts by collecting records of learning different types of problems. Also, this data is used to determine the difficulty level of problems in a next step.

When a user persistently uses a learning device and learning method program, according to the present invention, data about a concept and data about the degree of understanding a problem type can be accumulated. Also, the user's understanding is evaluated and learning materials customized to the user can be provided. Through an intelligent visual dictionary, the meaning of a concept may be understood, and a relation between concepts may be easily realized because relevant concepts are provided with the concept. When clicking one of the concepts, a user may figure out at a glance how the concept is related to other concepts. When another relevant concept is retrieved, as the relevant concept is displayed with previous concepts, it is possible to retrieve from the top-level concept to the most fundamental concept.

Also, the learning device and method may improve learning effects by helping a user understand a relation between problems, a concept related to a problem, and a relation between concepts. A cloud map, which in the case of this invention is a personalized mathematics encyclopedia, can be used. A concept, another concept that is selected based on the learning record of the question type related to the first concept, and a relation between the two concepts can be provided. The user may freely move to a desired concept from a difficult concept or to an easy concept by only a few clicks. Also, the learning device and method may visually display a learner's degree of understanding of the concept, clearly show the user's weak points to suggest further study, and may provide different problems and concepts according to the user. As various levels of mathematics problems are provided depending on a user's demands, students may study step-by-step at their own pace.

Using a multi-dimensionally accumulated learning history, the learning device and method predict a student's grade and help the student study effectively to achieve his or her goal. Also, a teacher may create personalized curriculum for a class. The teacher may provide content appropriate for a student's needs, and may check each student's progress and understanding.

Also, using an extensively defined DB, a learning method can be easily and quickly designed for any learning process of any country. The present invention enables teachers to effectively teach mathematics, which may ease the financial burden of tutoring and supplemental education, and may raise student's mathematics achievement.

A user may learn concepts necessary for further learning, and develop logical thinking for solving problems. Also, the present invention may provide a learning method in which learners may autonomously acquire an understanding of logical concept structures of mathematics and the like. Also, the present invention may improve learners' logical thinking, thus producing a student capable of solving various kinds of transformed problems related to a learned concept.

Also, the present invention continuously develops a cloud map by reflecting understanding of a concept based on a percentage of correct responses provided by a learner in a test situation. Accordingly, the present invention may provide the learner with a customized learning method. The present invention may provide a learning method that assists learners in understanding how a learned concept and other concepts are combined and varied according to a problem.

### DESCRIPTION OF DRAWINGS

FIG. 1 illustrates a relation between terminals and a learning device according to an embodiment of the present invention;

FIG. 2 illustrates an internal configuration of a learning device according to an embodiment of the present invention;

FIG. 3 illustrates a main configuration of a processing unit according to an embodiment of the present invention;

FIG. 4 illustrates a main configuration of a cloud map output unit according to an embodiment of the present invention;

FIG. 5 illustrates a connection between a problem and a concept, which are respectively stored in the problem storing unit and the concept storing unit, according to an embodiment of the present invention;

FIG. 6 illustrates an example in which a relation between concepts in the concept map storing unit is defined according to an embodiment of the present invention;

FIG. 7 illustrates an example of a cloud map according to a defined relation between concepts in FIG. 6;

FIG. 8 illustrates a cloud map, which is differently set based on a learning course and a user, according to an embodiment of the present invention;

FIGS. 9 and 10 illustrate an example in which a cloud map according to an embodiment of the present invention is displayed;

FIG. 11 illustrates a process in which a cloud map based on a user is formed according to an embodiment of the present invention;

FIGS. 12 and 13 illustrate an adaptive cloud map according to an embodiment of the present invention;

FIG. 14 illustrates an adaptive cloud map according to an embodiment of the present invention;

FIGS. 15 to 17 illustrate a cloud page provided to a user, according to an embodiment of the present invention;

FIGS. 18 to 23 illustrate an example of a page on which a cloud map provided to a user is displayed according to an embodiment of the present invention; and

FIG. 24 illustrates a flowchart corresponding to an example of a process of an adaptive learning method using a relational concept map, according to an embodiment of the present invention.

### BEST MODE

The present invention will be described in detail with reference to the accompanying drawings. In the following description, it is to be noted that, when the functions of conventional elements and the detailed description of elements related with the present invention may make the gist of the present invention unclear, a detailed description of those elements will be omitted. The embodiment of the present invention described hereinafter is provided for allowing those skilled in the art to more clearly comprehend the present invention. Therefore, it should be understood that the shape and size of the elements shown in the drawings may be exaggeratedly drawn to provide an easily understood description of the structure of the present invention.

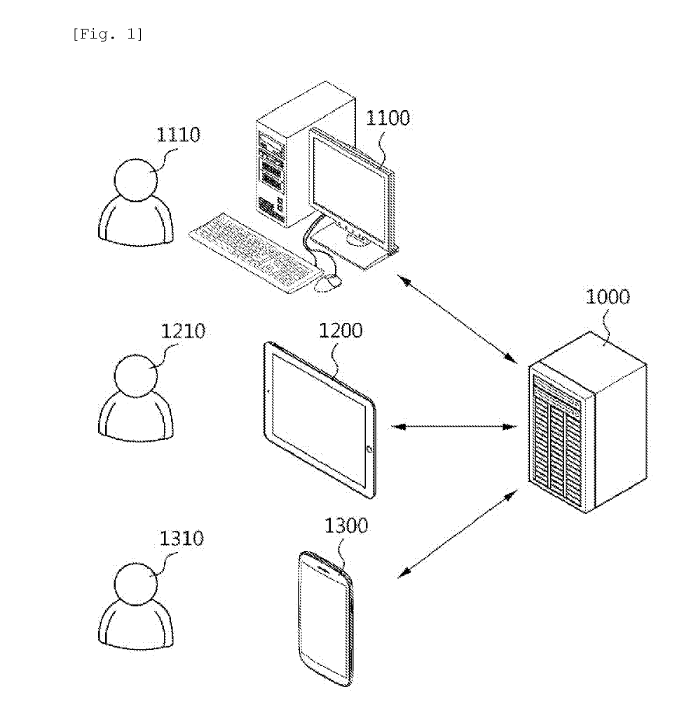

FIG. 1 illustrates a relation between terminals and a learning device according to an embodiment of the present invention. FIG. 1 illustrates a learning device 1000 according to an embodiment of the present invention, multiple users 1110, 1210, and 1310, and multiple terminals 1100, 1200, and 1300. The learning device 1000, generally in a form of a server, is connected to the multiple terminals 1100, 1200, and 1300 through a network. The network may be a wireless or wired network, and may be any network capable of data communication between the server and the terminals.

In FIG. 1, a user 1110 connects to the learning device 1000 through a network, using a PC 1100; a user 1210 connects to the learning device 1000 through a network, using a tablet PC 1200; and a user 1310 connects to the learning device 1000 through a network, using a smart phone 1300. The kinds of the terminals and the number of the users are an example, and the learning device 1000 may be a complex server connected to multiple devices.

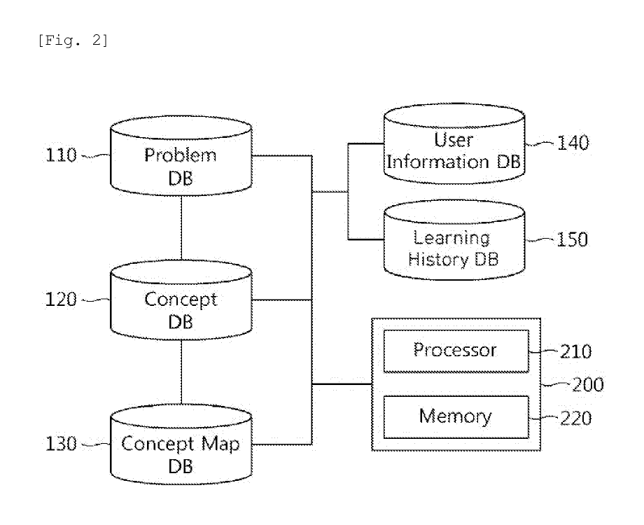

FIG. 2 illustrates an internal configuration of a learning device according to an embodiment of the present invention. The learning device 1000 includes: a problem DB 110 that is a problem storing unit for storing problems for learning; a concept DB 120 that is a concept storing unit for storing concepts; a concept map DB 130 that is a concept map storing unit for storing a relation between concepts; a user information DB 140 that is a user information storing unit for storing user information; and a learning history DB 150 that is a learning history storing unit for storing learning histories of each user. These DBs can be configured by combining or separating two or more of them according to need. These DBs may be commonly called a DB unit.

A processing unit 200 provides a user with adaptive learning content by using data stored in the DBs. The processing unit 200 is configured to include a processor 210 and a memory 220. The memory 220 stores a program for operating the learning device and may permanently or temporarily store data necessary for operating the learning device.

The problem storing unit 110 stores many problems for learning, for example, mathematics problems. These problems each contain problem content, which explains the problem itself, and a solution. Also, the problems may include a prompt for presenting the principle of the solution, which explains the solution in stages by linking it to a concept. When the prompt is included, because a user may study the principle of a solution step-by-step while consulting the prompt rather than immediately referring to the answer to learn the solution of the problem, the degree of understanding may be improved in comparison with learning by referring to only the solution. Also, as the prompt is linked to a relevant concept, the user may learn the relevant concept using a cloud map.

A concept storing unit 120 stores concepts corresponding to each node of a cloud map according to an embodiment of the present invention. These concepts each include: a concept name for intuitively explaining content of the concept to a user; a concept type for distinguishing the category of the concept; and a concept explanation for explaining the content of the concept in detail. The concept name is, for example, “properties of equality”. The concept type includes a definition, a theorem, a proof, and a method. The concept type enables a user to realize the category of the concept, and there may be two or more concepts that have the same concept name and different concept types. The concept means a certain term necessary for learning and may be categorized into a definition, a theorem, a proof, and a method. Consequently, learning can be performed based on a concept regarding a problem rather than based on the problem.

Also, the concept explanation according to the embodiment of the present invention may be differently provided depending on a user's level. Even for the same concept, according to the user's level, an easier concept explanation is provided to a low-level user, whereas a deep concept explanation is provided to a high-level user. Accordingly, it is possible to provide the concept explanation adaptive to the user's level. Because the concepts stored in the concept storing unit 120 are linked to the problems of the problem storing unit 110, a concept involved in each problem may be provided. Conversely, a problem involved in each concept may be provided.

In the concept map storing unit 130, a relation between the concepts stored in the concept storing unit 120 is defined and stored. The concept map storing unit 130 is a main component for representing a cloud map because it stores a relation between the concepts to implement the cloud map. As the concepts in the concept storing unit 120 correlate with each other according to the data in the concept map storing unit 130, the concept map storing unit may be referred to as a relational concept map storing unit 130.

Also, because the concept map storing unit 130 not only stores a relation between the concepts but defines a relational order between the concepts, it may be referred to as a concept pivot storing unit. A single concept has either a previous concept or a next concept, or both, as a relation with another concept. The previous concept and the next concept may be provided in plural numbers. For example, the previous concept of the present concept, “linear function”, is “function”, and the next concept may be defined as “linear regression”. The previous concept should be understood in advance to understand the present concept, and the next concept is understood after understanding the present concept. In this example, the previous concept of the “linear regression” may be “function”.

This relation between the concepts may define a learning step based on a concept, and may be adaptively changed depending on a learning curriculum, a user's level, and the user's degree of understanding. As the relation between the concepts is adaptively changed, a concept map customized to a user may be provided and the learning effect can be raised.

Also, linking strength is set between the concepts. The concepts, in which a correlation with another concept is defined, may have a strong linking relation or a weak linking relation. Because this linking strength can be changed depending on a user's level or the degree of understanding, an adaptive concept map may be provided. For example, when the user's degree of understanding a certain concept is high, the linking strength between the corresponding concept and another concept may be weaker. When the linking strength is less than a predetermined value, the concept may be excluded from a cloud map to avoid repeatedly presenting the content to the learner.

The user information storing unit 140 stores information about multiple users using a learning device. Not only a user's ID and password to log in to the learning device, but also various kinds of information such as a curriculum list, a level, a score, and the like may be stored.

The learning history storing unit 150 stores a learning history on a user basis. The learning history includes learning records based on a problem and a concept. When a certain problem is learned, a record representing that the problem has been learned and a record indicating whether the answer is right or wrong are stored. Also, the learning history can be stored for concepts, which are linked to the corresponding problem. If a certain problem is linked to two concepts, when a user learns the problem, the learning history is stored for the linked two concepts. Also, as a user learns a problem, the degree of understanding a concept that is linked to the problem is also stored. Therefore, the degree of understanding the concept may be realized and this has a great effect on learning. In addition, the degree of understanding may be stored only for the problem, and the degree of understanding the concept may be realized through the correlation.

For example, when 5 problems connected to a single concept are studied and 3 right answers are submitted, the degree of understanding the concept becomes 60%. As a result, in all the pages displaying the corresponding concept, the user's degree of understanding the concept may be explicitly displayed or may be displayed when a pointer is over the concept name. Also, an additional problem about the corresponding concept may be studied according to need, to raise understanding thereof. This is possible because problems are linked to a concept and problems linked to the concept can be extracted.

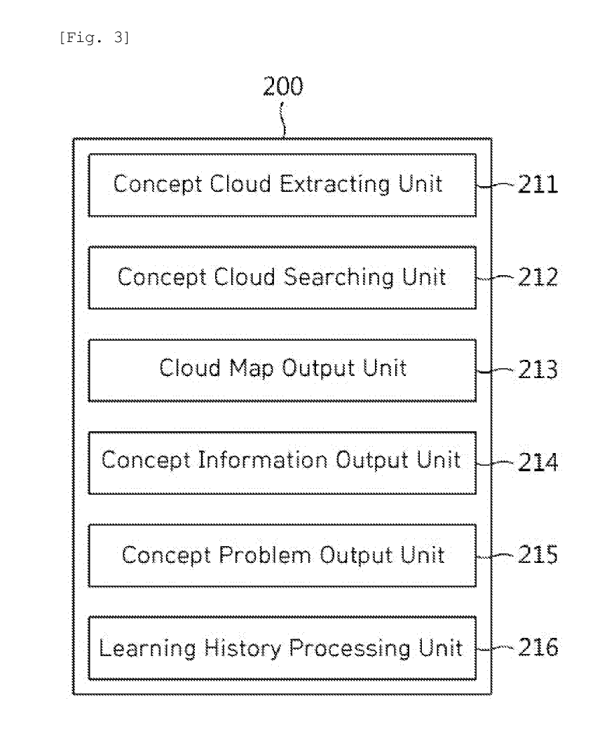

FIG. 3 illustrates a main configuration of a processing unit 200 according to an embodiment of the present invention. The processing unit 200 serves to provide an adaptive learning method to a user, using data stored in the various DBs. The processing unit 200 includes: a concept cloud extracting unit 211 for extracting a concept, selected by a user, from the concept storing unit 120; a concept cloud searching unit 212 for searching the concept storing unit 120 for a concept desired by a user; a cloud map output unit 213 for outputting a cloud map in a user's terminal, using a concept and a relevant concept extracted from the concept storing unit 120 and the concept map storing unit 130; a concept information output unit 214 for extracting a concept name, a concept type, and a concept explanation from the concept storing unit 120 and for outputting them; a concept problem output unit 215 for extracting a problem linked to a concept from the problem storing unit 110 and for outputting it; and a learning history processing unit 216 for storing a learning history in the learning history storing unit 150 by understanding a problem learned by a user and a concept linked to the problem. The concrete operations and roles of each unit will be described in detail later.

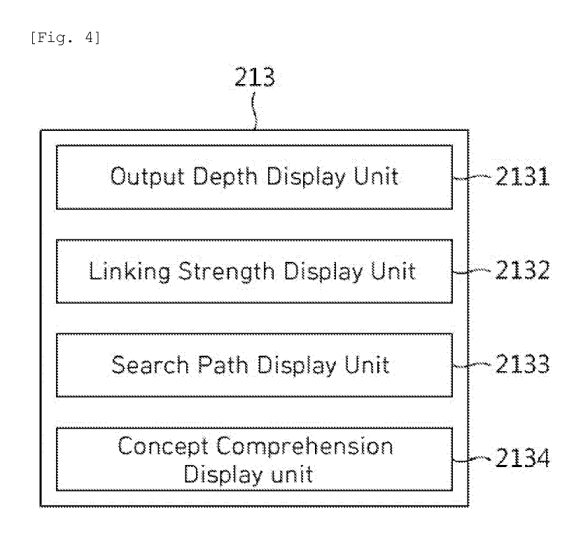

FIG. 4 illustrates a main configuration of a cloud map output unit 213 of FIG. 3 according to an embodiment of the present invention. The cloud map output unit 213 includes: an output depth display unit 2131 in which different expressions are displayed according to a depth of a relevant concept of the selected concept; a linking strength display unit 2132 in which different expressions are displayed according to linking strength established between concepts; a search path display unit 2133 that represents a path of concepts retrieved by a user; and a concept comprehension display unit 2134 that displays each user's degree of understanding a concept. The concrete operations and roles of each unit will be described in detail later.

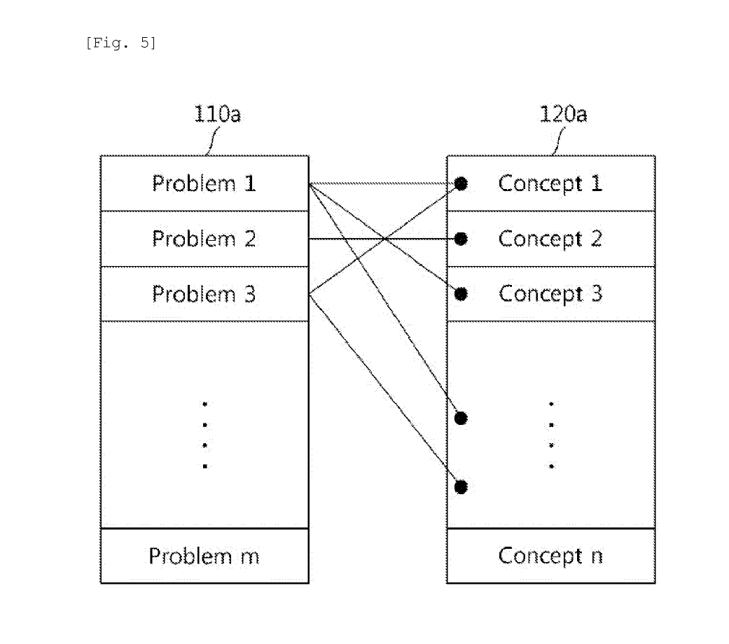

FIG. 5 illustrates a connection between a problem and a concept, which are respectively stored in the problem storing unit 110 and the concept storing unit 120, according to an embodiment of the present invention. Suppose that m number of problems 110a including Problem 1 to Problem m are stored in the problem storing unit 110 and that n number of concepts 120a including Concept 1 to Concept n are stored in the concept storing unit 120. A connection is established between a problem stored in the problem storing unit 110 and a concept stored in the concept storing unit 120. For example, Problem 1 is connected to Concept 1, Concept 3, and another concept; Problem 2 is connected to Concept 2; and Problem 3 is connected to Concept 1 and another concept.

Therefore, a user may check a relevant concept for each problem and may study a concept related to a problem if he or she wants to do so. For example, when a user studying Problem 1 checks relevant concepts and intends to study Concept 1, a concept name, a concept type, and a concept explanation of the Concept 1, each of which is stored in the concept storing unit 120, may be extracted for learning. Also, by learning Problem 3, which is another problem linked to the Concept 1, the degree of understanding of the concept may be evaluated and improved. In other words, because a problem and a concept are closely connected with each other, a user may experience multidimensional learning and may simultaneously acquire understanding of both the problem and the concept. Also, as described above, as a learning history can be updated or stored for a problem and a concept at the same time, the learning effect of the learning device can be improved.

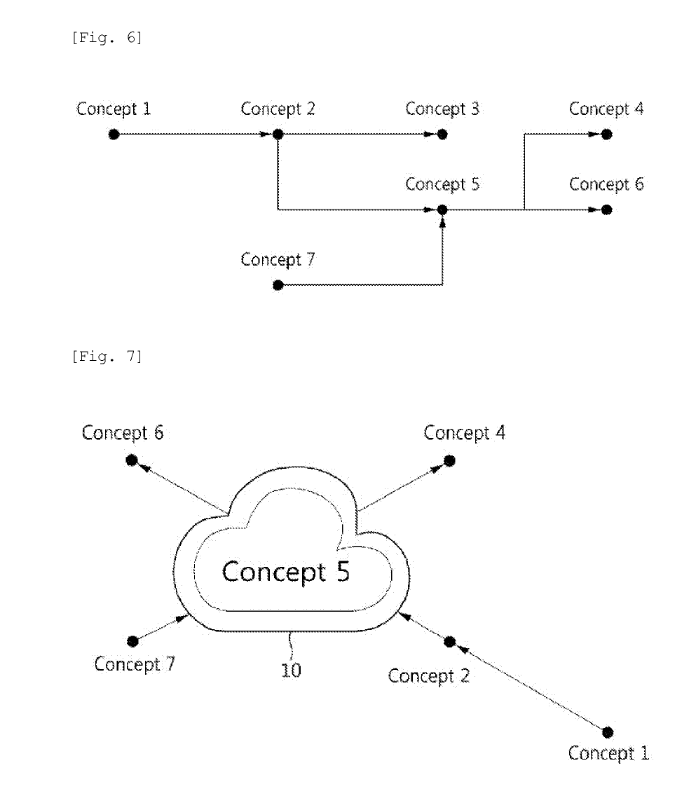

FIG. 6 illustrates an example in which a relation between concepts in the concept map storing unit 130 is defined according to an embodiment of the present invention. A next concept of Concept 1 is defined as Concept 2, and a next concept of the Concept 2 is defined as Concept 3 and Concept 5. The Concept 2 is defined as a previous concept of the Concept 3, but a next concept of the Concept 3 is not defined. In terms of a learning step, the Concept 3 is considered as a concept that does not have a next learning step. Also, for Concept 5, Concept 7 is defined as a previous concept, and Concept 4 and Concept 6 are defined as a next step.

FIG. 7 illustrates an example of a cloud map according to a defined relation between concepts in FIG. 6. Concept 5 marked with a cloud icon 10 is a current concept. A user may easily recognize a name of the current selected concept through the cloud icon 10. Referring to FIG. 6, the current concept, which is Concept 5, has Concept 2 and Concept 7 as a previous concept, and a direction of the relation between the concepts is expressed with an arrow. Similarly, the current concept, which is Concept 5, has Concept 4 and Concept 6 as a next concept, and a direction of the relation between the concepts is expressed with an arrow. A cloud map visually represents a relation between concepts, thus enabling a user to intuitively understand the relation between the concepts and to study based on the concepts. The cloud map may be referred to as a personalized math encyclopedia.

On the other hand, Concept 1 is also illustrated as a previous concept of Concept 2. Research on a user's usage pattern and comprehension concludes that the most effective display method is displaying previous concepts up to depth 2 and next concepts up to depth 1. Accordingly, the previous concepts are displayed up to depth 2 in order to raise user's comprehension and accessibility. Many times, the current concept is accessed when user's degree of understanding is low. In this case, displaying the previous concepts up to depth 2 rather than depth 1 is advantageous because the user may figure out his or her degree of understanding and determine which concept needs to be learned first. For intuitive comprehension and effective learning, it is desirable that a value of the depth for displaying previous concepts is greater than that for displaying next concepts. By understanding the definition of a relation between concepts, the output depth display unit 2131 of FIG. 4 displays the previous and next concepts up to a suitable depth.

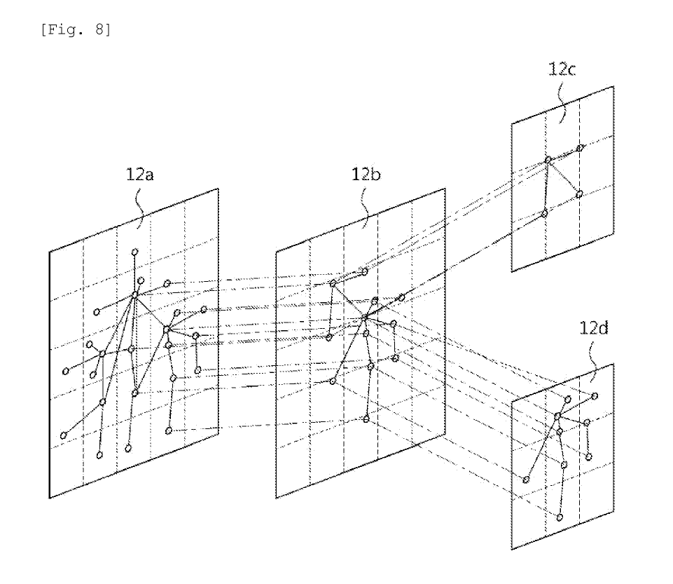

FIG. 8 illustrates a cloud map, which is differently set based on a learning course and a user, according to an embodiment of the present invention. There is a cloud map based on a learning course 12b, which includes concepts extracted from a whole cloud map 12a in which a relation between concepts is established. If the whole cloud map 12a includes all the concepts for mathematics study, the cloud map based on a learning course 12b only includes concepts according to a learning course. In other words, necessary concepts are extracted depending on a curriculum or a level and the extracted concepts are included in the cloud map based on a learning course 12b. According to a selected learning course, the cloud map based on a learning course 12b is primarily provided to a user. Depending on a configuration of the learning device, when the user individually selects the whole cloud map 12a, the whole cloud map 12a can be checked. According to a learning course, when difficult or easy concepts are displayed in the cloud map, such concepts may be a hindrance to learning. Therefore, to concentrate on important and necessary concepts in the learning course, the cloud map based on a learning course is primarily displayed.

Also, for users studying the same learning course, different cloud maps 12c and 12d can be provided depending on a level or the degree of understanding the concept. Cloud maps based on a user 12c and 12d are extracted from the same cloud map based on a learning course 12b, but the extracted concepts are different. This is because a necessary concept is different according to a user's level. Also, when learning of a concept has been completed and when it is determined that the degree of understanding the concept is high, the concept is excluded from the cloud map, and thus cloud maps are different according to users. Consequently, a cloud map provided to each user is made differently, and by providing a cloud map appropriate for a user, the user may be enticed to learn a concept having a higher priority.

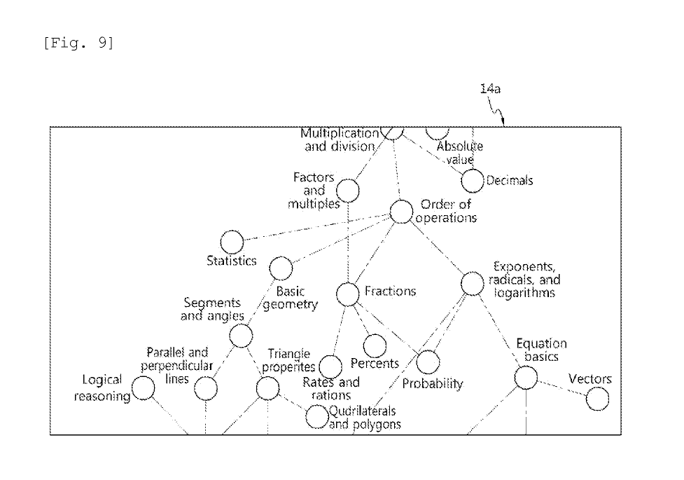

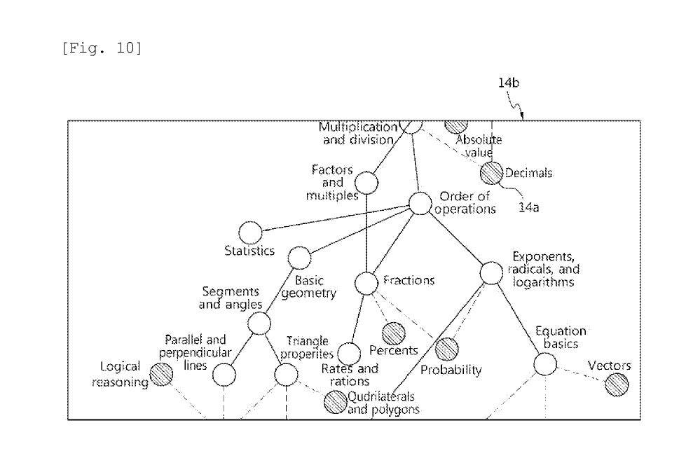

FIGS. 9 and 10 illustrate an example in which a cloud map according to an embodiment of the present invention is displayed. A cloud map 14a of FIG. 9 shows all the concepts of a corresponding part and a relation between them. This may be a whole cloud map 12a of FIG. 8. Also, in a cloud map 14b of FIG. 10, for example, a concept, Decimals 14a is displayed with hatch lines and is connected with other concepts by a broken line rather than a full line. The cloud map 14b of FIG. 10 may be referred to as a cloud map based on a learning course 12b or a cloud map based on a user 12c or 12d in FIG. 8. The concept Decimals 14a is a concept excluded from a corresponding learning course, or a concept that is not provided to a user because the user has completed studying of the concept. Practically, when the map is displayed in a screen of the learning device, by displaying neither the concept Decimals 14a nor the connection lines between the concept Decimals 14a and other concepts, only concepts necessary for the corresponding learning course or concepts needed for the user may be provided.

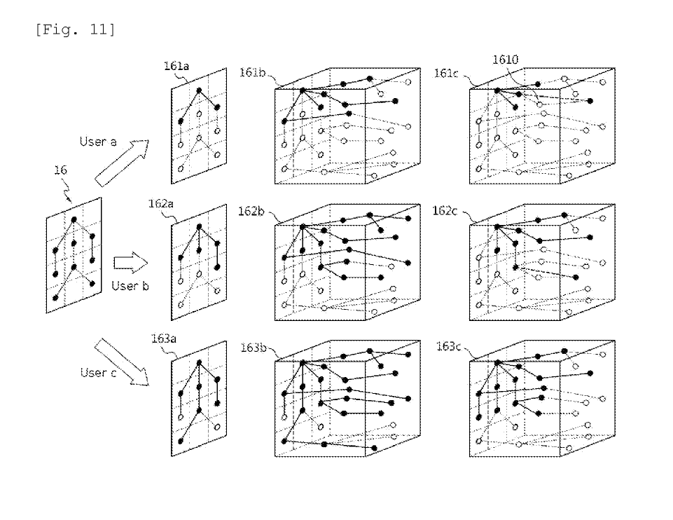

FIG. 11 illustrates a process in which a cloud map based on a user is formed according to an embodiment of the present invention. First, when a user a, a user b, and a user c study the same learning course, a cloud map 16, according to the learning course, is illustrated. The users start learning in the same cloud map 16, but as the users each study the learning course, cloud maps based on a user 161a, 162a, and 163a have different configurations after a certain period of time. In the cloud maps based on a user 161a, 162a, and 163a, a black circle indicates a concept of which study has not been completed, and a white circle indicates a concept of which study has been completed.

When relevant sub-concepts are additionally expressed, a difference between the cloud maps based on a user 161b, 162b, and 163b is clearly recognized. Concepts of the cloud maps based on a user 161a, 162a, and 163a are root concepts, which are important basic concepts for learning, and concepts additionally displayed in the cloud maps based on a user 161b, 162b, and 163b are sub-concepts, which are dependent on the root concepts. On the other hand, after further studies progress, a difference between the cloud maps based on a user 161c, 162c, and 163c are more obvious. Because users' degrees of understanding of each concept are different, the provided cloud maps may be different. In other words, a cloud map 161c is provided to the user a, a cloud map 162c is provided to the user b, and a cloud map 163c is provided to the user c. Referring to the cloud maps, it is confirmed that the user a understands relatively more concepts than user b and user c for the same period of time. The degree of understanding a concept can be determined according to the percentage of correct answers of problems linked to the corresponding concept.

Also, when the user has completed learning of a concept 1610, the concept 1610 is excluded and a previous concept of the concept 1610 and a next concept of the concept 1610 are directly related to each other. In other words, when learning of a concept has been completed, the definition of a relation between concepts can be changed. As different cloud maps depending on comprehension of the concept can be displayed for each user, adaptive cloud maps can be provided.

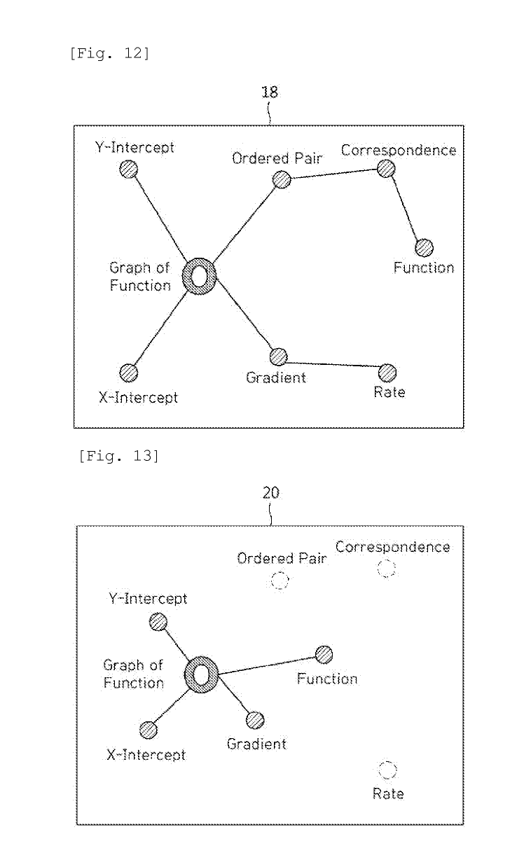

FIGS. 12 and 13 illustrate an adaptive cloud map according to an embodiment of the present invention. To explain a cloud map that is changed according to the progress of learning, FIG. 12 illustrates a cloud map 18 before learning. In FIG. 12, around a current concept, “Graph of function”, multiple relevant concepts, “y-intercept”, “x-intercept”, “ordered pair”, “correspondence”, “function”, “gradient”, and “rate” are displayed. In this case, when a user has completed learning of the concepts “rate”, “ordered pair”, and “correspondence”, and when it is determined that learning about the concepts is no longer needed, the concepts “rate”, “ordered pair”, and “correspondence” are excluded and only remaining concepts are displayed in connection with the current concept in a cloud map 20 illustrated in FIG. 13. Here, as concepts between the current concept and the concept “function” are excluded, the concept “function” is directly related to the current concept “Graph of a function”.

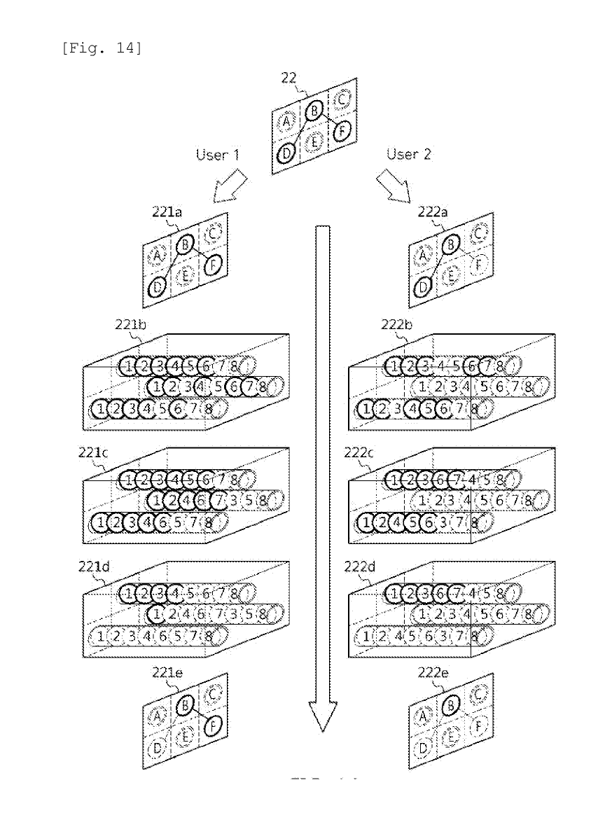

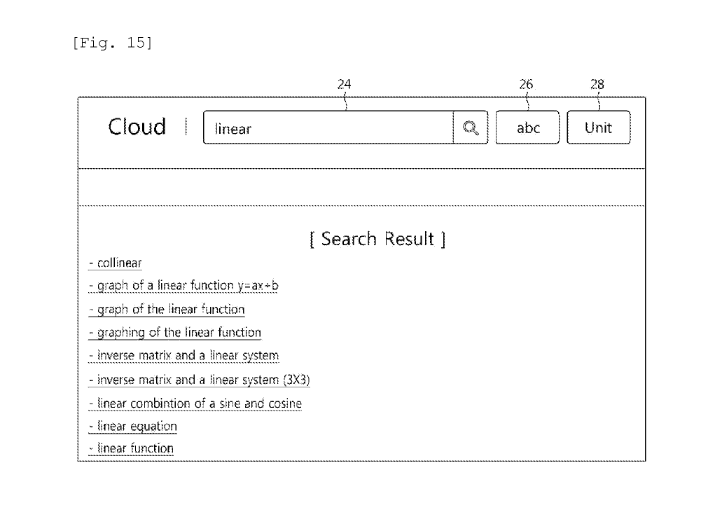

FIG. 14 illustrates an adaptive cloud map according to an embodiment of the present invention. Because user 1 and user 2 study the same learning course, the same cloud map 22 based on a learning course is provided to the users. When learning is started, the cloud map 22 contains root concepts B, D, and F. These root concepts each are connected with 8 sub-concepts. The root concepts are basic concepts corresponding to a basis of learning, and the sub-concepts connected to the root concepts can be defined as dependent concepts that need to be understood according to the basic concept.

Referring to a cloud map 221b of user 1, as learning progresses, for example, among sub-concepts of the root concept D, learning of concept 5, concept 7, and concept 8 has been completed. Accordingly, the processing unit of a learning device reestablishes a relation between the concepts and stores the relation reestablished according to the user in the concept map storing unit or in the learning history storing unit. In the cloud map 221c of user 1, the reestablished relation can be confirmed. Among sub-concepts of the root concept D, the concept 5, concept 7, and concept 8 of which learning has been completed are set as posterior concepts, and a priority of concept 6 of which learning has not been completed is raised. Also, when user 1 has completed learning of all the sub-concepts of the root concept D through further studying as in the cloud map 221d, the concept D is excluded from the root concepts of user 1 as in the cloud map 221e.

In a cloud map 222a of user 2 who has a higher learning level, the root concept F is excluded in advance. Like in the case of user 1, as learning progresses, a relation between concepts is reestablished as shown in the cloud maps 222b, 222c, and 222d. As a result, when learning of sub-concepts of the root concept D has been completed, the concept D is additionally excluded from the root concepts of user 2 as shown in the cloud map 222e.

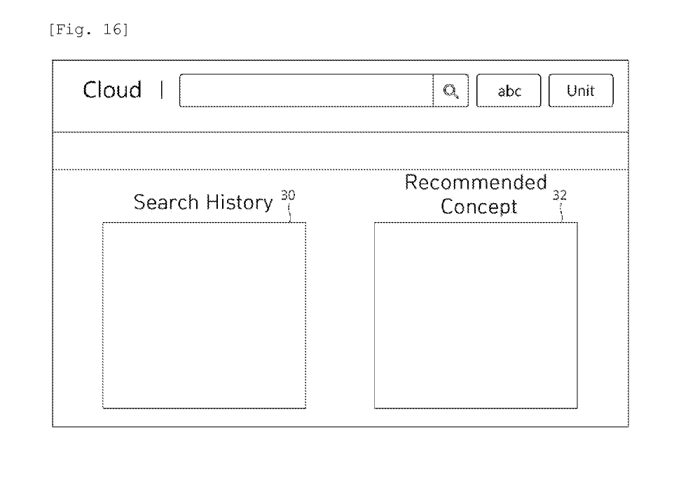

FIGS. 15 to 17 illustrate a cloud page provided to a user, according to an embodiment of the present invention. The cloud page provides a search textbox 24 for searching for a concept by inputting a desired search word, an alphabet search button 26 for displaying alphabetized concepts and for selecting one among them, and a learning process search button for checking and selecting relevant concepts of each chapter according to a learning course.

FIG. 15 illustrates an exemplified page when a user inputs “linear” in the search textbox 24 and clicks a search button. In a search result window shown in the lower part of the page, concepts which include the name “linear” are displayed among the concepts stored in the concept storing unit. Therefore, the user may retrieve a concept that he or she wants to learn, and may easily access the concept. Also, the search history is stored for further use in the user information storing unit.

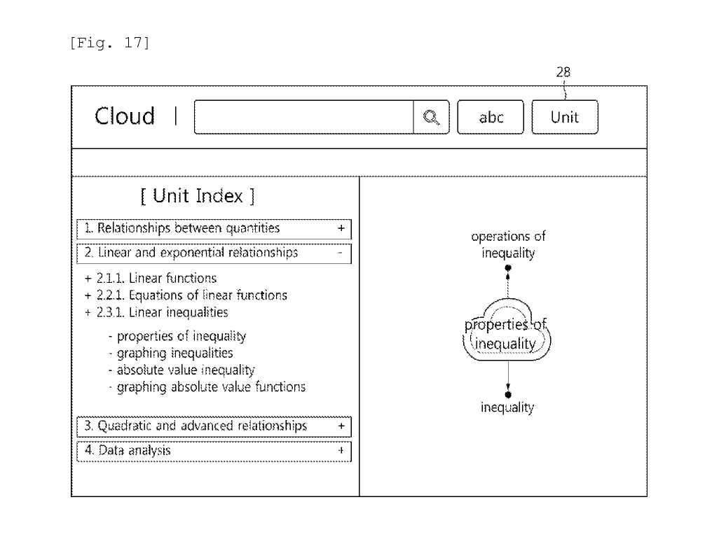

FIG. 16 illustrates an example of a start-up page of a cloud page. When a user accesses a cloud page, a search history window 30 is displayed on the left side. The search history window, based on search history information stored in the user information storing unit, arranges concepts that are previously searched for and enables the user to easily access the concepts again. On the right side, a recommended concept window 32 is displayed. The recommended concept window 32 also shows an adaptive characteristic, and it recommends concepts that are determined to be necessary for each user with reference to content stored in the learning history storing unit. For example, a next concept of a concept of which learning has been completed can be recommended, or when because of the low percentage of correct answers, it is determined that comprehension of a concept is low, the corresponding concept can be recommended. Also, a concept related to the previously retrieved concept can be recommended. The user may immediately access a concept by selecting one among the recommended concepts.

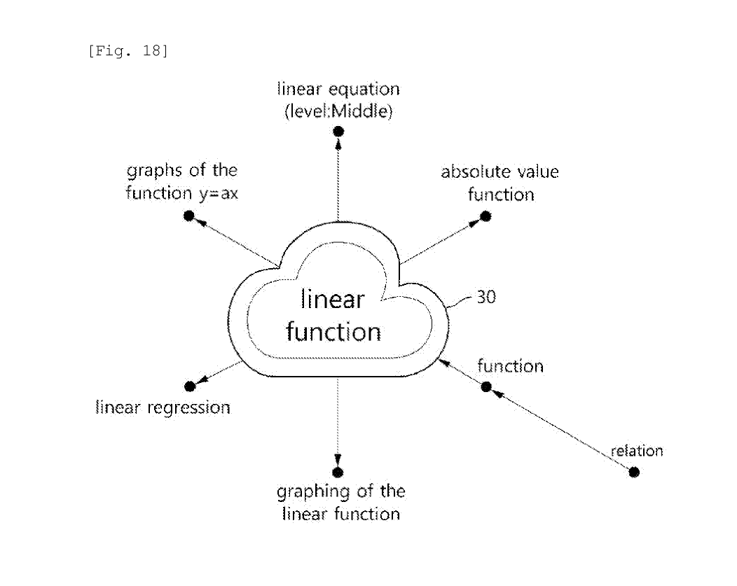

FIG. 17 illustrates an example of a learning course search page for checking relevant concepts of each chapter according to a learning course in a cloud page. A learning course that a user is studying includes multiple chapters, and common concepts are established for each of the multiple chapters. When the user selects the title of a chapter, it is unfolded and common concepts established for the corresponding chapter are displayed. In this case, the user may immediately access a corresponding common concept by clicking it. For example, when “properties of inequality”, which is one of the common concepts of chapter 2.3.1, is clicked in the left side of the page, a cloud map in which the selected concept is set as a current concept is displayed on the right side.

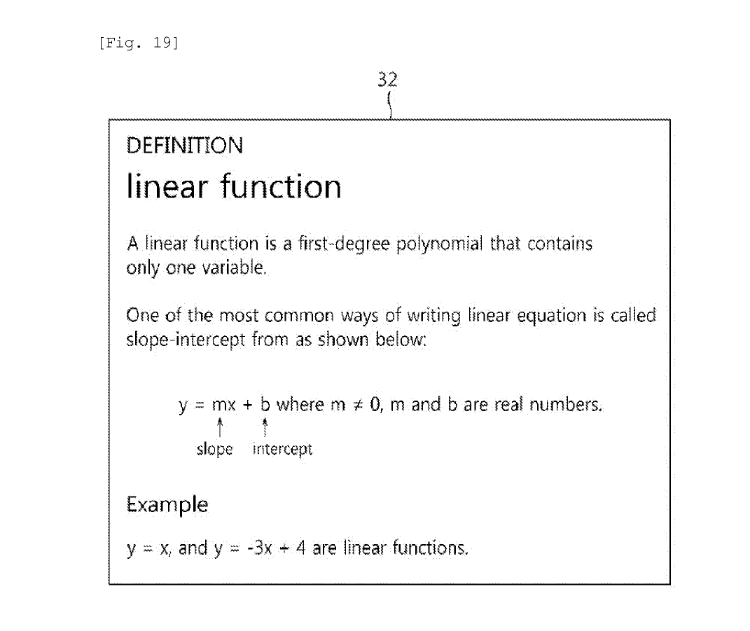

FIGS. 18 to 23 illustrate an example of a page on which a cloud map provided to a user is displayed according to an embodiment of the present invention. First, FIG. 18 illustrates a cloud map displayed when a user selects a concept “linear function” in the search result of FIG. 15. A cloud map visually expresses a relation between concepts stored in the concept map storing unit, and each node represents a concept. A selected current concept is displayed within a cloud icon 30 and other relevant concepts are displayed around the current concept. A previous concept of the current concept is “function”, and a previous concept of the concept “function” is “relation”. The other concepts are next concepts following the current concept. By the output depth display unit 2131 of FIG. 4, previous concepts are displayed up to depth 2, and next concepts are displayed up to depth 1. Also, by the output depth display unit 2131, concepts at depth 1 are displayed in smaller text than the current concept, and concepts at depth 2 are displayed in smaller text than the concepts at depth 1, to raise readability and to facilitate understanding of the relation between the concepts.

In the example, concepts are linked to each other by a full line. By the linking strength display unit 2132 of FIG. 4, linking strength between concepts can be displayed in a cloud map. When linking strength between concepts is strong, it is marked with a full line, whereas when linking strength is weak, it is marked with a broken line, so that the linking strength between concepts is easily recognized.

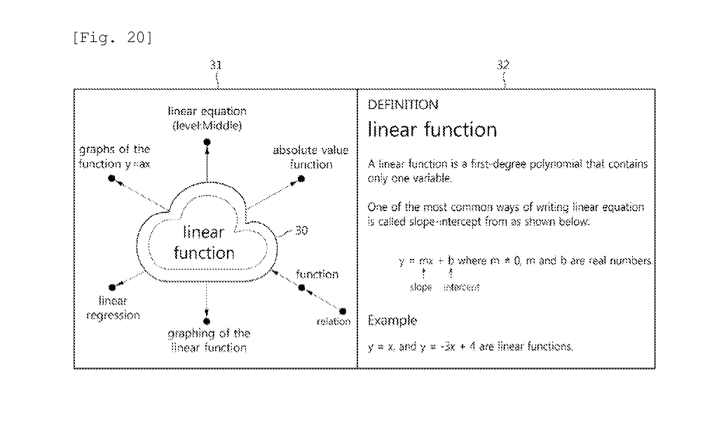

FIG. 19 illustrates an example of a page on which a concept type and a concept explanation are displayed when a user clicks the current concept “linear function”. In a concept information window 32, “DEFINITION”, corresponding to a concept type, is displayed in the first line; “linear function”, corresponding to a concept name, is displayed in the next line; and a concept explanation is displayed below the concept name. By selecting a concept to learn, a user is provided with a type and explanation related to the concept, and may learn basic knowledge about the concept. Also, explanations about other concepts that are displayed on the page can be easily accessed. Also, as shown in FIG. 20, because a cloud map 31 and the selected concept information window 32 are simultaneously displayed in the left and right side of the same page, it is easy to check an explanation while retrieving several concepts.

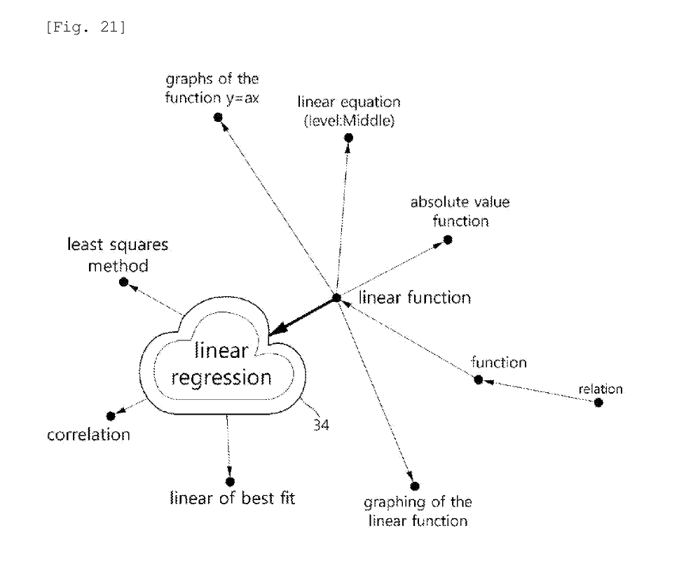

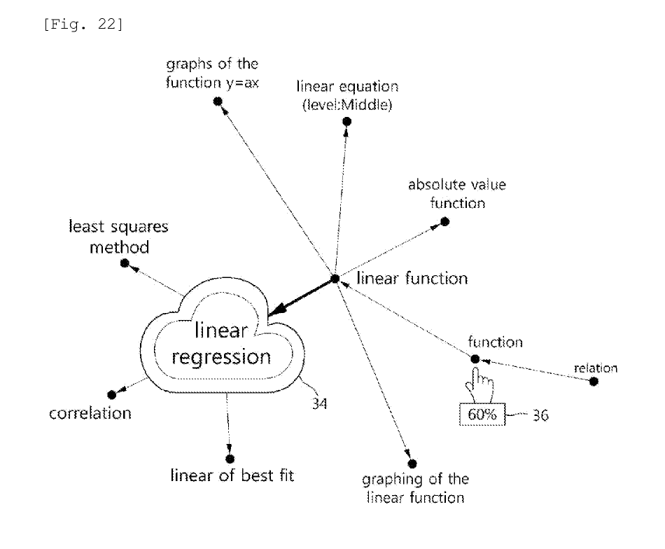

FIG. 21 illustrates an example of a page displayed when a user selects a concept “linear regression” in the cloud map illustrated in FIG. 18. A concept selected by a user, “linear regression” is a current concept and is marked with a cloud icon 34, and next concepts in which a relation with the current concept is defined are additionally displayed. In this case, generally, previously displayed concepts are shown at the same time, thus enabling a user to understand a relation between the concepts.

On the other hand, a path through which a user retrieves concepts is displayed on a page to enable checking the search path. The search path display unit 2133 of FIG. 4, for example, may display the search path using colors. In the case of an unsearched path, the arrow between concepts is displayed in gray, whereas in the case of a searched path, it may be displayed in blue. FIG. 21 illustrates an example in which a line between concepts, which corresponds to a path searched by a user, is represented by a bold arrow.

FIG. 22 illustrates an example of a page in which comprehension of a concept is checked. As described above, a user's degree of understanding of each concept included in a cloud map is figured out based on a user's learning history stored in the learning history storing unit. For example, when a pointer is over the concept of “function”, “60%”, which is the degree of understanding of the corresponding concept, is displayed on the page. The concept comprehension display unit of FIG. 4 serves to display the degree of understanding of a concept on a page, and it is desirable to display the degree of understanding using the text color of a concept name and to display an exact value when a pointer is over the concept. For example, when a learning history of a concept does not exist, a concept name is displayed in black. When the degree of understanding of a concept is low, medium, or high, a concept name may be displayed in red, orange, or blue, respectively.

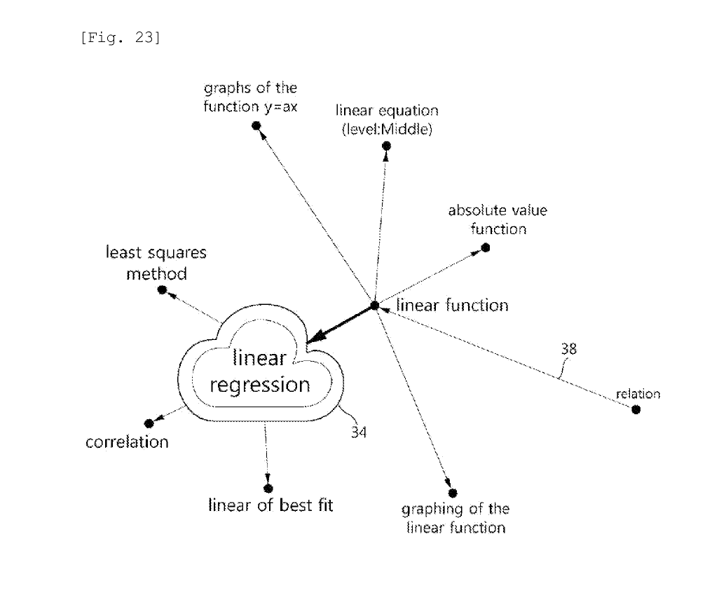

FIG. 23 illustrates an example of a cloud map page according to a reestablished relation between concepts. In a cloud map illustrated in FIG. 22, when it is determined that learning has been completed because a user's degree of understanding a concept “function” is high, the concept of “function” is excluded, and a relation between a previous concept “relation” and a next concept “linear function” can be reestablished and a direct link 38 is set between the two concepts. In other words, a cloud map can be adaptively changed according to a user.

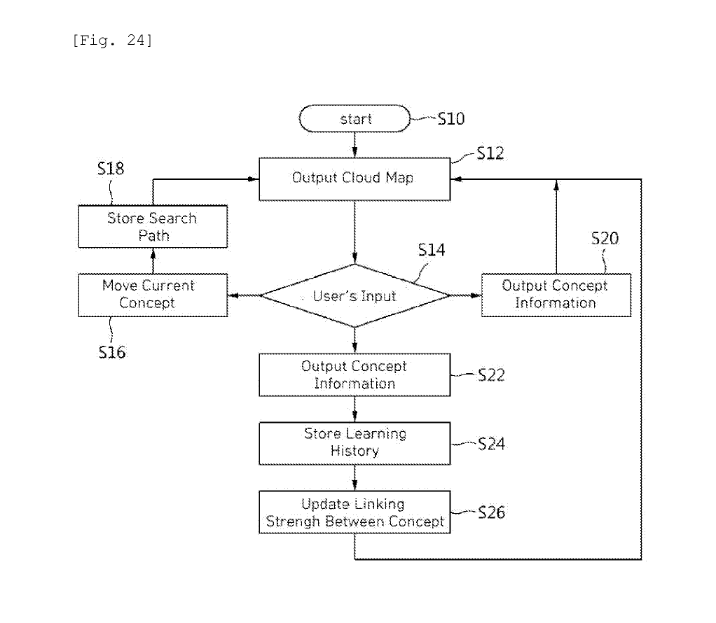

FIG. 24 illustrates a flowchart corresponding to an example of a process of an adaptive learning method using a relational concept map, according to an embodiment of the present invention. First, a process starts at step S10, and when a user selects a concept, a cloud map defined depending on the user is displayed at step S12. At step S14, when a user's input is detected while waiting for input, the process progresses into step S16, S20, or S22, according to the input. First, among concepts of the displayed cloud map, when the user selects a concept different from a current concept, a current concept movement, in which the selected concept is set as a current concept, is performed at step S16. Then, at step S18, a concept before the movement and a concept after the movement are stored as a search path in the user information storing unit. At step S12, a concept map updated based on the moved current concept is output and the search path is also displayed.

Again, the process progresses into step S14, and user's input is waited for. When a user selects a current concept, for example, by clicking it, concept information is output at step 20 by outputting a concept information window of the corresponding concept in a user's terminal. If the user selects solving a problem corresponding to a concept at step S14, the process progresses into step S22 and outputs a concept problem corresponding to the current concept in the user's screen. The user solves one or more of the provided problems, and the learning history is stored in the learning history storing unit. Using the stored learning history, linking strength between concepts is updated at step S26, and for example, when it is determined that learning has been completed because of a high degree of understanding, the process excludes the corresponding concept from the user's cloud map.

As described above, the adaptive learning device and method using a relational concept map, according to the present invention, are not limited to the configurations and methods of foregoing embodiments, but all or a part of the embodiments may be selectively combined so as to be variously changed.

A learning device and a learning method, according to the embodiment of the present invention, are described mainly with mathematics, but may be applied to various fields including history, science, language, and the like, without limitation to mathematics. The scope of the invention is not limited to the embodiments but it should be determined by the accompanying claims.

### INDUSTRIAL APPLICABILITY

The present invention relates to a learning device and method used for education, which may improve efficiency and value of a learning process by enabling a user to experience and learn online various kinds of adaptive education content at schools and homes.

1. An adaptive learning device using a relational concept map, which displays learning content in a user's terminal connected by a network, and which processes the learning content provided to a user using a processor and a memory, to assist the user in learning, comprising:
a problem storing unit in which problems are stored for learning;
a concept storing unit in which concepts are stored in connection with the problems;
a concept map storing unit in which a relation between the concepts is stored;
a learning history storing unit in which a learning history for each user is stored; and
a processing unit for providing the user with a cloud map, which is a relational concept map, using data stored in the problem storing unit, the concept storing unit, the concept map storing unit, and the learning history storing unit,
wherein the user's learning history for each of the problems is connected with the problem and one or more of the concepts, and
wherein the processing unit comprises: a concept cloud extracting unit for extracting a concept, selected by the user, from the concept storing unit; a concept cloud searching unit for searching the concept storing unit for a concept desired by the user; a cloud map output unit for providing a cloud map to the user's terminal, using a concept and a relevant concept extracted from the concept storing unit and the concept map storing unit; and a concept problem output unit for extracting a problem connected to a concept from the problem storing unit and for outputting the problem.

2. The adaptive learning device of claim 1, wherein the concept storing unit stores concepts, wherein each of the concepts corresponds to a node of the cloud map, and stores a concept name for intuitively explaining content of a concept; a concept type for distinguishing a category of the concept; and a concept explanation for explaining the content of the concept in detail, for each of the concepts.

3. The adaptive learning device of claim 2, wherein the concept explanation is stored differently according to a user's level.

4. The adaptive learning device of claim 1, wherein the concept map storing unit stores one or more previous concepts and one or more next concepts in connection with the concept stored in the concept storing unit.

5. The adaptive learning device of claim 4, wherein the concept map storing unit stores linking strength between relevant concepts.

6. The adaptive learning device of claim 1, wherein the cloud map output unit comprises: an output depth display unit in which a different expression is displayed according to a depth of a relevant concept of a selected concept; a linking strength display unit in which a different expression is displayed according to linking strength established between concepts; and a concept comprehension display unit that displays each user's degree of understanding of each concept.

7. The adaptive learning device of claim 1, wherein the cloud map output unit outputs a different cloud map depending on a learning course and a user.

8. The adaptive learning device of claim 7, wherein a concept determined that learning of the concept has been completed is excluded from the cloud map provided to the user, and a relation between the concepts stored in the concept map storing unit is reestablished and updated.

9. The adaptive learning device of claim 7, wherein the concept stored in the concept storing unit is categorized into a root concept, which is a basic concept corresponding to a basis of learning, and a sub-concept, which is a dependent concept connected to the root concept, and when it is determined that the user has completed learning of the sub-concepts connected to the root concept, the corresponding root concept is excluded from the cloud map provided to the user.

10. An adaptive learning method using a relation concept map, which displays learning content in a user's terminal connected by a network, and which processes and provides the learning content using a processor and a memory to assist the user in learning, wherein the adaptive learning method provides a learning method using a learning device comprising:
a problem storing unit in which problems are stored for learning;
a concept storing unit in which concepts are stored in connection with the problems;
a concept map storing unit in which a relation between the concepts is stored;
a learning history storing unit in which a learning history for each user is stored; and
a processing unit for providing the user with a cloud map, which is a relational concept map, using data stored in the problem storing unit, the concept storing unit, the concept map storing unit, and the learning history storing unit,
wherein the adaptive learning method comprises:
connecting, by the learning history storing unit, each user's learning history about each of the problems with the problem and one or more of the concepts;
extracting, by the concept cloud extracting unit, a concept selected by the user from the concept storing unit;
searching, by the concept cloud searching unit, the concept storing unit for a concept desired by the user;
providing, by the cloud map output unit, a cloud map to the user's terminal, using a concept and a relevant concept extracted from the concept storing unit and the concept map storing unit; and
extracting a problem connected to a concept from the problem storing unit by the concept problem output unit and outputting the problem.

11. The adaptive learning method of claim 10, wherein the concept storing unit stores concepts, each of the concepts corresponding to a node of the cloud map, and stores a concept name for intuitively explaining content of a concept; a concept type for distinguishing a category of the concept; and a concept explanation for explaining the content of the concept in detail, for each of the concepts.

12. The adaptive learning method of claim 11, wherein the concept explanation is stored differently according to a user's level.

13. The adaptive learning method of claim 10, wherein the concept map storing unit stores one or more previous concepts and one or more next concepts in connection with the concept stored in the concept storing unit.

14. The adaptive learning method of claim 13, wherein the concept map storing unit stores linking strength between relevant concepts.

15. The adaptive learning method of claim 10, wherein providing the cloud map to the user's terminal comprises:
displaying a different expression according to a depth of a relevant concept of a selected concept;
displaying a different expression according to linking strength established between concepts; and
displaying each user's degree of understanding of each concept.

16. The adaptive learning method of claim 10, wherein a different cloud map is output depending on a learning course and a user in providing the cloud map to the user's terminal.

17. The adaptive learning method of claim 16, further comprising:
excluding a concept determined that learning of the concept has been completed from the cloud map provided to the user, and updating a relation between the concepts stored in the concept map storing unit by reestablishing the relation.

18. The adaptive learning method of claim 16, wherein the concept stored in the concept storing unit is categorized into a root concept, which is a basic concept corresponding to a basis of learning, and a sub-concept, which is a dependent concept connected to the root concept, further comprising:
determining that the user has completed learning of the sub-concepts connected to the root concept; and
excluding the corresponding root concept from the cloud map provided to the user when it is determined that the user has completed learning of the sub-concepts connected to the root concept.
